(19) United States
(12) Patent Application Publication
(10) Pub. No.: US 2026/0073830 A1
(43) Pub. Date: Mar. 12, 2026

(54) PIXEL CONTROL METHOD AND DISPLAY DEVICE USING THE SAME

(71) Applicant: LG DISPLAY CO., LTD., Seoul (KR)

(72) Inventors: Yong Chul KWON, Paju-si (KR); Young Woo JO, Paju-si (KR)

(73) Assignee: LG DISPLAY CO., LTD., Seoul (KR)

(21) Appl. No.: 19/248,018

(22) Filed: Jun. 24, 2025

(30) Foreign Application Priority Data
Sep. 6, 2024 (KR) 10-2024-0121711

(51) Int. Cl. G09G 3/20; G09G 3/32; G09G 3/3233

(52) U.S. Cl. CPC G09G 3/2007; G09G 3/2096; G09G 3/3233; G09G 3/32; G09G 2300/0852; G09G 2300/0861; G09G 2310/0286; G09G 2310/08; G09G 2320/0242; G09G 2320/045

(57) ABSTRACT

A pixel control method may set a maximum grayscale value of one-frame data of an input image as a maximum input grayscale, and match the maximum input grayscale with a maximum output grayscale and match input grayscales equal to or smaller than the maximum input grayscale with grayscales equal to or smaller than the maximum output grayscale. Duty data controlling a lighting period of pixels is selected according to the maximum input grayscale. The maximum input grayscale varies depending on a maximum grayscale value of the input image. The maximum output grayscale is a fixed grayscale value determined according to the number of bits of pixel data. The lighting period of the pixels indicated by the duty data vary depending on the maximum input grayscale. A display device using the pixel control method is also disclosed.

### CROSS-REFERENCE TO RELATED APPLICATION

This application claims the benefit of and priority to Korean Patent Application No. 10-2024-0121711, filed Sep. 6, 2024, the entire contents of which are incorporated herein by reference for all purposes.

### BACKGROUND

### 1. Technical Field

The present disclosure relates to a pixel control method and a display device using the same.

### 2. Description of Related Art

Various flat panel displays such as a liquid crystal display and an electroluminescence display are known. An electroluminescence display can display an input image by emitting light by itself using light-emitting elements respectively provided in pixels without a backlight. The light-emitting elements of the electroluminescence display may be divided into organic light-emitting elements and inorganic light-emitting elements depending on a material for a light-emitting layer.

Recently, a display device using a light-emitting diode (LED) that is an inorganic light-emitting element, for example, a micro LED as a light-emitting element for a pixel has been attracting attention as a next-generation display device. Since the LED is made of an inorganic material, the LED does not require a separate encapsulation layer for protecting an organic material from moisture and has excellent reliability and long lifetime compared to an organic light-emitting diode (OLED). In addition, the micro LED has a high turn-on speed, is excellent in light emission efficiency, and has impact resistance.

In pixels that display a video image using the micro LEDs, color coordinates may be shifted depending on an amount of current flowing in the micro LED or a current density of the micro LED to cause image quality deterioration. To solve such a problem, a pulse width modulation (PWM) driving method that expresses grayscale of pixel data by maintaining the current density of the micro LED constant and adjusting a light emission time of the micro LED has been suggested. A display panel driving circuit that drives pixels using the PWM driving method requires a circuit that generates a voltage having a sweep waveform, a data drive integrated circuit (IC) with the number of channels increased two times due to data lines connected to the sweep waveform, thereby causing an increase in circuit cost.

The description of related art should not be considered prior art merely because it is mentioned in or associated with this section. The description of related art includes information that describes one or more aspects of the subject technology, and the description in this section does not limit the scope of the invention.

### SUMMARY

Embodiments of the present disclosure solve the above-described shortcomings and/or problems.

One or more aspects of the present disclosure provide a pixel control method and a display device capable of improving image quality by improving a problem of shift of color coordinates shift while preventing an increase in circuit cost.

The problems addressed by the embodiments of the present disclosure are not limited to those described above, and other problems not described will be clearly understood by those skilled in the art from the following description.

A pixel control method according to one embodiment of the present disclosure includes: setting a maximum grayscale value of one-frame data in an input image as a maximum input grayscale; matching the maximum input grayscale with a maximum output grayscale and matching input grayscales equal to or smaller than the maximum input grayscale with grayscales equal to or smaller than the maximum output grayscale; and selecting duty data controlling a lighting period of pixels according to the maximum input grayscale. The maximum input grayscale varies depending on a maximum grayscale value of the input image. The maximum output grayscale is a grayscale value determined according to the number of bits of pixel data. The lighting period of the pixels indicated by the duty data varies depending on the maximum input grayscale.

The duty data may include duty ratio information of a light emission signal that changes in a form of any one of linear, nonlinear, and stepwise depending on the maximum input grayscale. The light emission signal may be applied to pixels to which the pixel data is written.

A light emission time of the pixels may be decreased when a duty ratio of the duty data is decreased.

The pixel control method may further include: determining whether the maximum input grayscale belongs to an ultra-low grayscale range relatively lower in a low grayscale range; controlling the pixels in a normal mode when the maximum input grayscale belongs to a grayscale range outside the ultra-low grayscale range and controlling a frame rate to a reference frequency in the normal mode; and controlling the pixels in an ultra-low grayscale mode when the maximum input grayscale belongs to the ultra-low grayscale range, increasing the frame rate to a frequency higher than the reference frequency in the ultra-low grayscale mode, and increasing a data voltage that is output from a data driver.

The pixel control method may further include: increasing a gamma reference voltage that is supplied to the data driver, in the ultra-low grayscale mode.

The pixel control method may further include: adding an off-frame period during which black grayscale data set regardless of the pixel data of the input image is written to the pixels, in the ultra-low grayscale mode.

The pixel control method may further include: changing the gamma reference voltage in the off-frame period.

A display device according to one embodiment of the present disclosure includes: at least one display panel in which data lines, gate lines, and pixels are provided; a data driver configured to convert pixel data into a data voltage and supply the data voltage to the data lines; a gate driver configured to supply gate signals to the gate lines; and a timing controller configured to transmit the pixel data to the data driver and control the data driver and the gate driver. The timing controller executes the pixel control method.

Each of the pixels may include at least a red subpixel, a green subpixel, and a blue subpixel. Each of the red subpixel, the green subpixel, and the blue subpixel may include a driving transistor and a light-emitting element connected in series between a pixel driving voltage and a pixel ground voltage, and a switch transistor that is connected between the driving transistor and the pixel ground voltage or between the driving transistor and the light-emitting element, and is turned on in response to a gate-on voltage of the light emission signal.

The gate driver may include a first light emission (EM) driver configured to receive a first start pulse and a first clock as input and supply a first light emission signal to pixels provided in a first display area of the display panel, a second EM driver configured to receive a second start pulse and a second clock as input and supply a second light emission signal to pixels provided in a second display area of the display panel, and a third EM driver configured to receive a third start pulse and a third clock as input and supply a third light emission signal to pixels provided in a third display area of the display panel.

The timing controller may select a maximum grayscale value among grayscale values of pixel data to be written to the pixels in the first display area of the display panel as a first maximum input grayscale and output first duty data selected according to the first maximum input grayscale. The timing controller may select a maximum grayscale value among grayscale values of pixel data to be written to the pixels in the second display area of the display panel as a second maximum input grayscale and output second duty data selected according to the second maximum input grayscale. The timing controller may select a maximum grayscale value among grayscale values of pixel data to be written to the pixels in the third display area of the display panel as a third maximum input grayscale and output third duty data selected according to the third maximum input grayscale. The first duty data may include duty ratio information of the first start pulse and the first clock. The second duty data may include duty ratio information of the second start pulse and the second clock. The third duty data may include duty ratio information of the third start pulse and the third clock. A duty ratio of the first light emission signal may change in proportion to duty ratios of the first start pulse and the first clock. A duty ratio of the second light emission signal may change in proportion to duty ratios of the second start pulse and the second clock. A duty ratio of the third light emission signal may change in proportion to duty ratios of the third start pulse and the third clock.

The first EM driver may be provided in the first display area. The second EM driver may be provided in the second display area. The third EM driver may be provided in the third display area.

The at least one display panel may include a first display panel in which a first gate driver is provided in a display area, and a second display panel in which a second gate driver is provided in a display area. The first gate driver may include a first EM driver configured to receive a first start pulse and a first clock as input and supply a first light emission signal to pixels provided in the display area of the first display panel. The second gate driver may include a second EM driver configured to receive a second start pulse and a second clock as input and supply a second light emission signal to pixels provided in the display area of the second display panel.

The timing controller may select a maximum grayscale value among grayscale values of pixel data to be written to the pixels in the first display panel as a first maximum input grayscale and output first duty data selected according to the first maximum input grayscale. The timing controller may select a maximum grayscale value among grayscale values of pixel data to be written to the pixels in the second display panel as a second maximum input grayscale and output second duty data selected according to the second maximum input grayscale. The first duty data may include duty ratio information of the first start pulse and the first clock. The second duty data may include duty ratio information of the second start pulse and the second clock. A duty ratio of the first light emission signal may change in proportion to duty ratios of the first start pulse and the first clock. A duty ratio of the second light emission signal may change in proportion to duty ratios of the second start pulse and the second clock.

The timing controller may determine whether the maximum input grayscale belongs to an ultra-low grayscale range relatively lower in a low grayscale range. The timing controller may control the pixels in a normal mod when the maximum input grayscale belongs to a grayscale range outside the ultra-low grayscale range and control a frame rate to a reference frequency in the normal mode. The timing controller may control the pixels in an ultra-low grayscale mode when the maximum input grayscale belongs to the ultra-low grayscale range, increase the frame rate to a frequency higher than the reference frequency in the ultra-low grayscale mode, and increase a data voltage that is output from the data driver.

The display device may further include a gamma reference voltage supplier configured to supply a gamma reference voltage to the data driver. The timing controller may increase the gamma reference voltage that is output from the gamma reference voltage supplier, in the ultra-low grayscale mode.

The timing controller may add an off-frame period during which black grayscale data set regardless of pixel data in an input image is written to pixels.

The gamma reference voltage may be changed in the off-frame period.

According to the embodiments of the present disclosure, it is possible to drive the light-emitting elements with high efficiency and high luminance to achieve improvement of lifetime and low-power driving, to enable PWM driving of the light-emitting elements without providing additional data lines, and to simplify a configuration of a pixel circuit.

According to the embodiments of the present disclosure, it is possible to improve image quality by improving the problem of shift of color coordinates while preventing an increase in circuit cost.

According to the embodiments of the present disclosure, it is possible to increase a frame rate by setting an ultra-low grayscale mode and to reduce a lighting period of pixels by further providing a black data insertion period, thereby further improving image quality at an ultra-low grayscale.

The effects of the present disclosure are not limited to the effects described above, and other effects not described will be understood by those skilled in the art from the following description and the appended claims.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIGS. 1A and 1B are diagrams illustrating a display device according to an embodiment of the present disclosure;

FIG. 2 is a diagram illustrating an example of a tiled display according to the embodiment of the present disclosure;

FIG. 3 is a diagram illustrating an example of a gate driver;

FIG. 4 is a circuit diagram illustrating an example of a pixel circuit that can be applied to the display device according to the embodiment of the present disclosure;

FIG. 5 is a circuit diagram illustrating another example of a pixel circuit that can be applied to the display device according to the embodiment of the present disclosure;

FIG. 6 is a block diagram illustrating a pixel controller according to a first embodiment of the present disclosure;

FIG. 7 is a diagram illustrating grayscale conversion of input pixel data in the timing controller;

FIGS. 8 and 9 are diagrams illustrating duty data that varies depending on a maximum input grayscale;

FIG. 10 is a diagram illustrating an example where a lighting period of a pixel varies depending on a duty ratio of an EM signal selected according to the maximum input grayscale;

FIG. 11 is a diagram illustrating an example of display areas where turn-on times of pixels are controlled independently;

FIG. 12 is a waveform chart illustrating an example of EM start pulses illustrated in FIG. 11;

FIG. 13 is a diagram illustrating an example where lighting periods of pixels are controlled differently between the display areas illustrated in FIG. 11;

FIG. 14 is a diagram illustrating another example of display areas where turn-on times of pixels are controlled independently;

FIG. 15 is a diagram illustrating an example where turn-on times of pixels are controlled independently by display panel in the tiled display device;

FIG. 16 is a block diagram illustrating a pixel controller according to a second embodiment of the present disclosure;

FIG. 17 is a block diagram illustrating a pixel controller according to a third embodiment of the present disclosure;

FIG. 18 is a flowchart illustrating a pixel control method when an ultra-low grayscale mode is set;

FIG. 19 is a diagram illustrating an input grayscale to an output grayscale in the ultra-low grayscale mode;

FIG. 20 is a diagram illustrating duty data that varies depending on the maximum input grayscale in the ultra-low grayscale mode;

FIG. 21 is a diagram illustrating an example where a data voltage increases at an ultra-low grayscale; and

FIGS. 22 and 23 are diagrams illustrating a difference in frame rate between the ultra-low grayscale mode and a normal mode.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “consist of” used herein are generally intended to allow other components to be added unless the terms are used with the term “only.” Any references to singular may include plural unless expressly stated otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after,” “following,” “next to,” “before,” or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

The pixel circuit of the display device may include a plurality of transistors. A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor, since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal may swing between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

Hereinafter, various embodiments of the present disclosure will be described in detail with reference to the accompanying drawings.

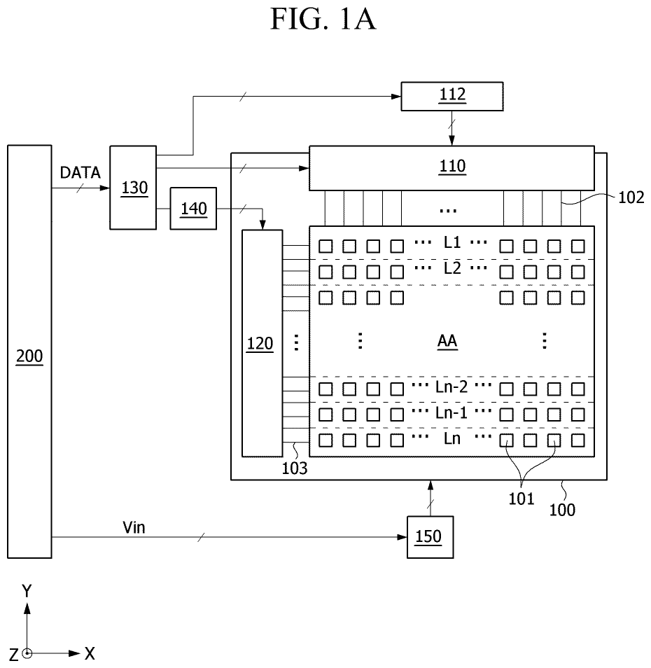

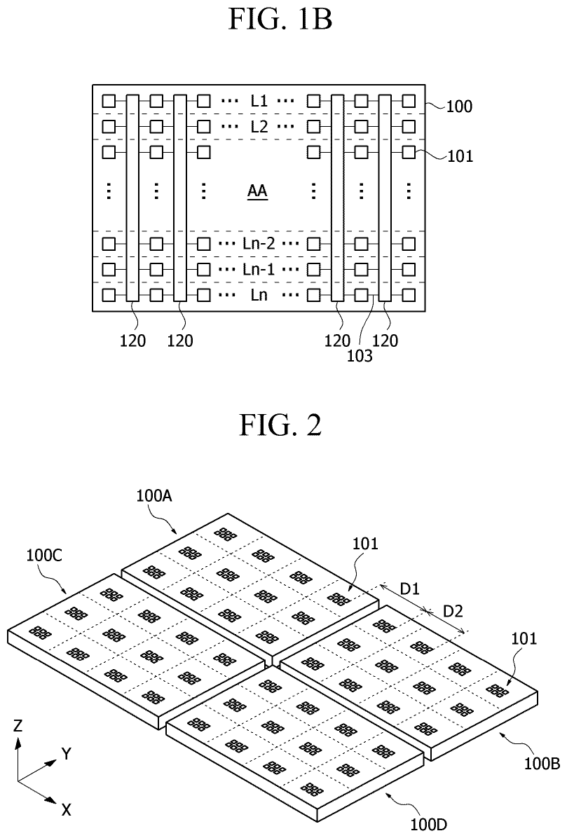

Referring to FIGS. 1A and 1B, a display device according to one embodiment of the present disclosure includes a display panel 100, a display panel driving circuit for writing pixel data to pixels 101 in the display panel 100, and a power supply 150 for generating power necessary for driving the pixels 101 and the display panel driving circuit.

A substrate of the display panel 100 may be, but is not limited to, a plastic substrate, a thin glass substrate, or a metal substrate. The display panel 100 may be, but is not limited to, a rectangular shaped panel having a length in the X-axis direction (or first direction), a width in the Y-axis direction (or second direction), and a thickness in the Z-axis direction (or third direction). For example, at least a portion of the display panel 100 may have a curved outer periphery.

The display panel 100 may be implemented as a non-transmissive display panel or a transmissive display panel. The transmissive display panel may be applied to a transparent display device in which an image is displayed on a screen and a real object is visible beyond the display panel. The display panel 100 may be fabricated as a flexible display panel. Additionally, the display panel 100 may be made of a stretchable panel that may be stretched.

A display area AA of the display panel 100 includes a pixel array for displaying an input image thereon. The pixel array includes a plurality of data lines 102, a plurality of gate lines 103 intersecting the data lines 102, and pixels 101 arranged in a matrix form. The display panel 100 may further include power lines commonly connected to the pixels 101. The power lines are commonly connected to the pixels and supply a constant voltage necessary for driving the pixels 101 to the pixels 101. The power lines may be implemented as long stripes of wires along either the first or second direction, or as mesh wires where the wires in the first direction and the wires in the second direction are electrically connected.

Each of the pixels 101 may be divided into a red sub-pixel, a green sub-pixel, and a blue sub-pixel for color implementation. Each of the pixels may further include a white sub-pixel. Each sub-pixel includes a pixel circuit for driving a light-emitting element. In the following, “pixel” may be interpreted as “subpixel.”

The pixel circuit may include an internal compensation circuit or may be connected to an external compensation circuit. The internal compensation circuit samples the electrical characteristics of the driving transistor for driving the light-emitting element, such as the gate-source voltage, and compensates the gate voltage of the driving transistor by the amount of change in the gate-source voltage. The external compensation circuit may apply a compensation value to the pixel data of the input image, based on the results of sensing the electrical characteristics of the driving transistor and/or light-emitting element using a sensing circuit connected to the pixel circuit, thereby compensating for the deviation or change in the electrical characteristics of the driving transistor and/or light-emitting element using the pixel data value. The internal compensation circuit and the external compensation circuit may prevent degrayscale of the pixels and extend the lifespan of the display even if deviations or changes occur in the electrical characteristics of the transistors and/or light-emitting elements of the subpixels.

The pixel array includes a plurality of pixel lines L1 to Ln. Where n is a natural number greater than or equal to 2. Each of the pixel lines L1 to Ln may include a plurality of subpixels arranged along the X-axis direction in the pixel array of the display panel 100. The pixels arranged in one pixel line may share a gate line 103. The sub-pixels arranged along the Y-axis direction may share the same data line 102. One horizontal period is a time obtained by approximately dividing one frame period by the total number of the pixel lines L1 to Ln.

Touch sensors may be arranged on the display panel 100 to sense touch inputs. The touch sensors may be arranged as an on-cell type or an add-on type on a display area AA of the display panel 100 or implemented as in-cell type touch sensors embedded in the pixel array.

The power supply 150 generates the constant voltages (or direct current (DC) voltages) required for driving the pixel array and the display panel driving circuit of the display panel 100 using a DC-DC converter. The DC-DC converter may include a charge pump, a regulator, a buck converter, a boost converter, and the like. The power supply 150 may adjust the level of the input voltage from a host system 200 to output constant voltages, such as a gate-low voltage, a gate-high voltage, a pixel driving voltage, a pixel ground voltage (hereinafter referred to as “ground voltage”), and the like.

The gate-high voltage and the gate-low voltage are supplied to a level shifter 140 and the gate driver 120. The constant voltages such as the pixel driving voltage and the ground voltage are supplied to the pixels 101 through the power lines commonly connected to the pixels 101. The pixel driving voltage may be supplied from a main power source of the host system 200 to the display panel 100. In this case, the power supply 150 does not need to output the pixel driving voltage.

The display panel driving circuit writes the pixel data of the input image to the pixels of the display panel 100 under the control of the timing controller 130. The display panel driving circuit includes a data driver 110, a gate driver 120, a gamma reference voltage supplier 112, and a level shifter 140. The display panel driving circuit may further include a touch sensor driver for driving the touch sensors. The touch sensor driver is omitted from FIG. 1A. The data driver 110 and the touch sensor driver may be integrated into one drive IC (Integrated Circuit). The timing controller 130, the power supply 150, the gamma reference voltage supplier 112, the level shifter 140, the data driver 110, and the touch sensor driver may be further integrated into the drive ID.

The gamma reference voltage supplier 112 may be implemented as a programmable gamma voltage circuit that receives a reference voltage from the power supply 150. The programmable gamma voltage circuit may vary the voltage level of the gamma reference voltage provided to the data driver 110 based on digital data from the timing controller 130, such as an input maximum grayscale value, which will be described later. The gamma reference voltage output from the gamma reference voltage supplier 112 is supplied to the data driver 110. The gamma reference voltage may be interpreted as a gamma tab voltage.

The dynamic range of the data voltage output from the data driver 110 is determined by the voltage range of the gamma reference voltage. The dynamic range of the data voltage is the range of voltages between the maximum voltage and the minimum voltage of a data voltage. Thus, the timing controller 130 may regulate the voltage level of the gamma reference voltage input to the data driver 110 to vary the data voltage output from the data driver 110 and charged to the pixels 101. For example, the timing controller 130 may vary the voltage level of the data voltage output from the data driver 110 by varying the gamma reference voltage based on the input maximum grayscale value.

The data driver 110 receives the pixel data of the input image provided as a digital signal from the timing controller 130 and outputs data voltages of the pixel data. The data driver 110 converts the pixel data of the input image into gamma-compensated voltages using a digital-to-analog converter (hereinafter referred to as “DAC”) arranged in the data output channels and outputs the data voltages. The gamma reference voltage output from the gamma reference voltage supplier 112 is divided into the gamma-compensated voltages for each grayscale by a voltage divider circuit in the data driver 110 and supplied to the DAC. The DAC generates the data voltage as the gamma-compensated voltage corresponding to the grayscale value of the pixel data. The data voltage output from the DAC is output to the data line 102 through an output buffer in each of the data output channels of the data driver 110. In the case of a pixel circuit with positive gamma compensation, the luminance of the pixel may increase as the data voltage output from the data driver 110 increases. In the case of a pixel circuit with negative gamma compensation, the luminance of the pixel may increase as the data voltage output from the data drive 110 decreases.

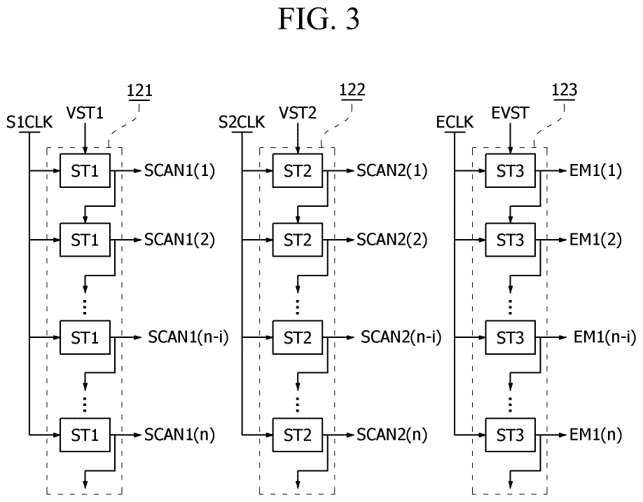

The gate driver 120 may be formed on the circuit layer of the display panel 100 along with the pixel circuit. The gate driver 120 may include circuits, such as one or more shift registers and/or one or more edge triggers, which output pulses of the gate signal under the control of the timing controller 130. The gate signal may include a plurality of gate signals with different pulse widths, phases, etc. In this case, the gate driver 120 may output a plurality of gate signals using a plurality of shift registers and/or edge triggers, as shown in FIG. 3.

The gate driver 120 may be arranged in the non-display area NA outside the display area AA in the display panel 100 or at least a portion thereof may be arranged in the display area AA. The gate driver 120 may be arranged in either a left non-display area NA or a right non-display area NA outside the display area AA in the display panel 100 to supply the gate signal to the gate lines 103 in a single feeding method. In the single feeding method, the gate signal is applied to one ends of the gate lines. The gate driver 120 may be arranged in the left non-display area NA and the right non-display area NA in the display panel 100 to apply the gate signal to the gate lines 103 in a double feeding method. In the double feeding method, the gate signal is applied simultaneously to both ends of the gate lines 103. At least some circuits of the gate driver 120 may be disposed within the display area AA. For example, as shown in FIG. 1B, the circuit of the gate driver 120 may be located between the pixels 101 within the display area AA.

The timing controller 130 receives the pixel data DATA of the input image and a timing signal synchronized with the pixel data DATA from the host system 200. The timing signal may include a vertical synchronization signal Vsync, a horizontal synchronization signal Hsync, and a data enable signal DE. A vertical period and a horizontal period may be known by counting the data enable signal DE, and thus the vertical synchronization signal Vsync and the horizontal synchronization signal Hsync may be omitted. The data enable signal DE has an interval of one horizontal period (1H).

The timing controller 130 may transmit pixel data DATA to the data driver 110, and control the data driver 110 and the gate driver 120. The timing controller 130 may control the operation timings of the data driver 110 and the gate driver 120 based on the timing signals Vsync, Hsync, and DE received from the host system 200. The gate timing control signal output from the timing controller 130 may be input to the gate driver 120 through the level shifter 140. The level shifter 140 may receive a gate timing control signal and generate a start pulse and a clock signal to provide them to the gate driver 120. The input signal to the level shifter 140 is a signal of a digital signal voltage level. The start pulse and the clock signal output from the level shifter 140 may swing between the gate-high voltage and the gate-low voltage. A data timing control signal generated from the timing controller 130 is transmitted to the data driver 110. The timing controller 130 may vary the grayscale value of the pixel data of the input image according to a preset algorithm, or may change the voltage level of the data voltage output from the data driver 110 by controlling the gamma reference voltage supplier 112.

The host system 200 may scale an image signal from a video source to match the resolution of the display panel 100, and may transmit it to the timing controller 130 together with the timing control signal.

A large-screen display device may be implemented as a tiled display in which a plurality of display panels are combined in a planar arrangement. FIG. 2 is a diagram illustrating an example of a tiled display device according to one embodiment of the present disclosure.

Referring to FIG. 2, the tiled display device includes a plurality of display modules arranged on an XY plane. The display modules include display panels 100A to 100D that reproduce an input image, and display panel driving circuits, respectively. Each of the display panels 100A to 100D includes gate drivers 120 provided in a display area AA as illustrated in FIG. 1B. Since the gate drivers 120 are provided in this manner, a non-display area NA can be minimized in an outer portion of each of the display panels 100A to 100D. For this reason, a seamless large-screen image can be reproduced among adjacent display panels 100. An interval D1 between an outermost pixel 101 in one display panel of the display panels 100A to 100D and an outermost pixel 101 in another display panel of the display panels 100A to 100D may be substantially the same as an interval D2 between adjacent pixels 101 in the display area AA of each of the display panels 100A to 100D.

In the tiled display device, a plurality of display modules may share one timing controller 130. The host system 200 may be connected to a plurality of timing controllers to transmit image signals to be reproduced on all display panels 100A to 100B that implement a large screen of the tiled display device, and synchronize the timing controllers 130.

FIG. 3 is a diagram illustrating an example of the gate driver 120. In FIG. 3, i in (n-i) is a positive integer smaller than n.

Referring to FIG. 3, the gate driver 120 may supply a plurality of gate signals, for example, first scan signals SCAN1(1) to SCAN1(n), second scan signals SCAN2(1) to SCAN2(n), and light emission signals (hereinafter, referred to as “EM signals”) EM(1) to EM(n) to pixels via a plurality of gate lines. In this case, the gate driver 120 may include a first gate driver 121 that outputs the first scan signals SCAN1(1) to SCAN1(n), a second gate driver 122 that outputs second scan signals SCAN2(1) to SCAN2(n), and a third gate driver 123 that outputs the EM signals EM(1) to EM(n). The first and second gate drivers 121 and 122 may be described as scan drivers, and the third gate driver 123 may be described as an EM driver.

The first gate driver 121 includes a plurality of signal transmitters ST1 connected in a cascade manner. The first gate driver 121 may receive a first start signal VST1 and a first clock S1CLK as inputs and may sequentially output the pulses of the first scan signals SCAN1(1) to SCAN1(n). The second gate driver 122 includes a plurality of signal transmitters ST2 connected in a cascade manner. The second gate driver 122 may receive a second start signal VST2 and a second clock S2CLK as input and may sequentially output the pulses of the second scan signals SCAN2(1) to SCAN2(n). The third gate driver 123 includes a plurality of signal transmitters ST3 connected in a cascade manner. The third gate driver 123 may receive a third start signal VST3 and a third clock ECLK as input and may sequentially output the pulses of the EM signals EM(1) to EM(n). The clocks S1CLK, S2CLK, and ECLK that are input to the gate drivers 121, 122, and 123 may include two or more clocks having different phases. The start signals VST1, VST2, and VST3 and the clocks S1CLK, S2CLK, and ECLK may be different in one or more of phase, pulse width, frequency, and a duty ratio.

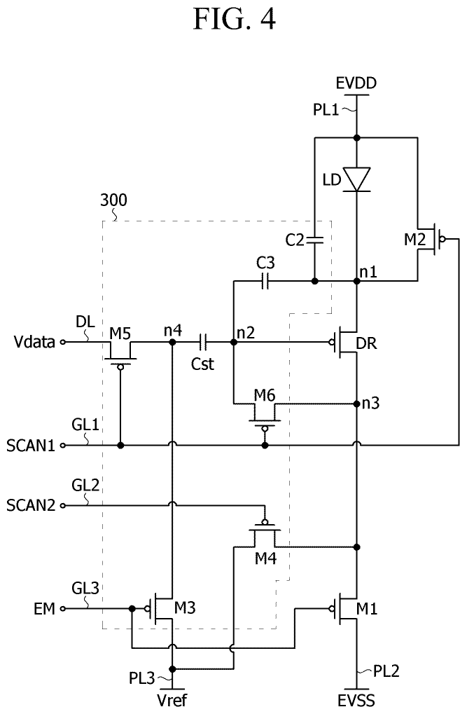

FIG. 4 is a circuit diagram illustrating an example of a pixel circuit that can be applied to the display device according to the embodiment of the present disclosure.

Referring to FIG. 4, the pixel circuit includes a light-emitting element LD, a driving transistor DR, switch transistors M1 and M2, and a compensation circuit 300. The driving transistor DR and the switch transistors M1 may be implemented by p-channel transistors, but the present disclosure is not limited thereto.

The light-emitting element LD may include an anode electrode, a cathode electrode, and a light-emitting layer. A pixel driving voltage EVDD may be applied to the anode electrode of the light-emitting element LD. The cathode electrode of the light-emitting element LD may be connected to the driving transistor DR. The light-emitting element LD may be an OLED or an inorganic LED element such as a mini LED or a micro LED, but the present disclosure is not limited thereto. A vertical structure may be made in which electrodes are provided in upper and lower portions of a semiconductor chip into which the light-emitting element LD is integrated, but the present disclosure is not limited thereto. The semiconductor chip into which the light-emitting element LD is integrated may be implemented in a lateral structure or a flip chip structure. The anode electrode of the light-emitting element LD may be connected to a first power line PL1 to which the pixel driving voltage EVDD is applied. The cathode electrode of the light-emitting element LD may be connected to a first node n1.

The light-emitting element LD, the driving transistor DR, and the switch transistors M1 may be connected in series between the pixel driving voltage EVDD and a ground voltage EVSS.

The driving transistor DR controls a current flowing through a drain-source channel according to a gate-source voltage. The gate-source voltage of the driving transistor DR varies depending on a data voltage Vdata of pixel data that is applied to a gate electrode of the driving transistor DR. The data voltage Vdata is output from the data driver 110. The current flowing through driving transistor DR changes depending on the data voltage Vdata. The light-emitting element LD may be driven by the current flowing through the drain-source channel of the driving transistor DR to emit light.

The driving transistor DR may be connected between the light-emitting element LD and a first switch transistor M1. The driving transistor DR includes a first electrode connected to the first node n1, the gate electrode connected to a second node n2, and a second electrode connected to a third node n3.

The first switch transistor M1 may be connected between the driving transistor DR and a second power line PL2 to which the ground voltage EVSS is applied, to switch a current path between the pixel driving voltage EVDD and the ground voltage EVSS. The first switch transistor M1 may be turned on in response to a gate-on voltage of the EM signal EM and may be turned off in response to a gate-off voltage of the EM signal. The gate-on voltage may be the gate low voltage VGL, and the gate-off voltage may be the gate high voltage VGH. When the first switch transistor M1 is turned on, the second power line PL2 may be connected to the driving transistor DR and the current may flow in the light-emitting element LD. When the first switch transistor M1 is turned off, the current path between the pixel driving voltage EVDD and the ground voltage EVSS is blocked, and no current flow in the light-emitting element LD. The first switch transistor M1 includes a first electrode connected to the third node n3, a gate electrode connected to a third gate line GL3 to which the EM signal EM is applied, and a second electrode connected to the second power line PL2.

The pixel circuit may further include a second switch transistor M2. The second switch transistor M2 may be connected between the cathode electrode and the anode electrode of the light-emitting element LD, and may be turned on in response to a gate-on voltage of the first scan signal SCAN1 and may be turned off in response to a gate-off voltage. When the second switch transistor M2 is turned on, the cathode electrode and the anode electrode of the light-emitting element LD are short-circuited, and light is not emitted from the light-emitting element LD. When the second switch transistor M2 is turned off, the current may flow in the light-emitting element LD. The second switch transistor M2 can prevent emission of light from the light-emitting element LD when the pixel circuit is initialized and a threshold voltage of the driving transistor DR is sampled. The second switch transistor M2 includes a first electrode connected to the anode electrode of the light-emitting element LD, a gate electrode connected to a first gate line GL1 to which the first scan signal SCAN1 is applied, and a second electrode connected to the first node n1.

The compensation circuit 300 is connected to a data line DL to which the data voltage Vdata of the pixel data is applied, gate lines GL1, GL2, and GL3 to which the gate signals SCAN1, SCAN2, and EM are applied, and the first to third nodes n1, n2, and n3. The compensation circuit 300 transfers the data voltage Vdata to the gate electrode of the driving transistor DR. The compensation circuit 300 compensates a gate voltage of the driving transistor DR by the threshold voltage of the driving transistor DR by sampling the threshold voltage of the driving transistor DR.

The compensation circuit 300 may include third to sixth switch transistors M1 to M6, a first capacitor Cst, a second capacitor C2, and a third capacitor C3, but the present disclosure is not limited thereto. The switch transistors M1 to M6 may be p-channel transistors, but the present disclosure is not limited thereto.

The third switch transistor M3 is turned on in response to the gate-on voltage of the EM signal EM and is turned off in response to the gate-off voltage of the EM signal EM. When the third switch transistor M3 is turned on, a fourth node n4 may be electrically connected to a third power line PL3 to which a reference voltage Vref is applied. The third switch transistor M3 includes a first electrode connected to the fourth node n4, a gate electrode connected to the third gate line GL3, and a second electrode connected to the third power line PL3.

The fourth switch transistor M4 is turned on in response to a gate-on voltage of the second scan signal SCAN2 and is turned off in response to a gate-off voltage of the second scan signal SCAN2. When the fourth switch transistor M4 is turned on, the third node n3 may be electrically connected to the third power line PL3 to which the reference voltage Vref is applied. The fourth switch transistor M4 includes a first electrode connected to the third power line PL3, a gate electrode connected to the second gate line GL2 to which the second scan signal SCAN2 is applied, and a second electrode connected to the third node n3.

The fifth switch transistor M5 is turned on in response to the gate-on voltage of the first scan signal SCAN1 and is turned off in response to the gate-off voltage of the first scan signal SCAN1. When the fifth switch transistor M5 is turned on, the data line DL to which the data voltage Vdata is applied may be electrically connected to the fourth node n4. The fifth switch transistor M5 includes a first electrode connected to the data line DL, a gate electrode connected to the first gate line GL1 to which the first scan signal SCAN1 is applied, and a second electrode connected to the fourth node n4.

The sixth switch transistor M6 is turned on in response to the gate-on voltage of the first scan signal SCAN1 and is turned off in response to the gate-off voltage of the first scan signal SCAN1. When the sixth switch transistor M6 is turned on, the second node n2 may be electrically connected to the third node n3. The sixth switch transistor M6 includes a first electrode connected to the second node n2, a gate electrode connected to the first gate line GL1, and a second electrode connected to the third node n3.

The first capacitor Cst may be connected between the second node n2 and the fourth node n4. The second capacitor C2 may be connected between the first power line PL1 and the first node n1. The third capacitor C3 may be connected between the first node n1 and the second node n2.

The pixel circuit illustrated in FIG. 4 may be driven for one frame period in an initialization step, a sampling step, a holding step, and a light emission step. The initialization step may include a first initialization step and a second initialization step. In the first initialization step, a voltage of the second scan signal SCAN2 is a gate-on voltage, and voltages of each of the first scan signal SCAN1 and the EM signal EM is a gate-off voltage. In the first initialization step, while the fourth switch transistor M4 is turned on, other switch transistors M1, M2, M3, M5, and M6 are in an off state. During the first initialization step, the driving transistor DR is in an off state.

In a second initialization step, the voltage of each of the first scan signal SCAN1 and the second scan signal SCAN2 is the gate-on voltage, and the voltage of the EM signal EM is the gate-off voltage. In the second initialization step, the second, fifth, and sixth switch transistors M2, M5, and M6 are turned on, and the fourth switch transistor M4 is maintained in an on state. Meanwhile, in the second initialization step, the first and third switch transistors M1 and M3 are in the off state. In the second initialization step, a voltage on the first node n1 increases and the driving transistor DR is turned on. In the second initialization step, a data voltage Vdata(n) is applied to the data line DL. The data voltage Vdata(n) is applied to the fourth node n4 via the fifth switch transistor M5. In the second initialization step, the reference voltage Vref is applied to the second and third nodes n2 and n3 via the fourth and sixth switch transistors M4 and M6.

In the sampling step, the voltage of the first scan signal SCAN1 is the gate-on voltage, and the voltage of each of the second scan signal SCAN2 and the EM signal EM is the gate-off voltage. Accordingly, in the sampling step, the second, fifth, and sixth switch transistors M2, M5, and M6 are in the on state, and the fourth switch transistor M4 is turned off. In the sampling step, the first and third switch transistors M1 and M3 are in the off state. In the sampling step, the voltage on the first node n1 is EVDD, and a voltage on the second node n2 is EVDD +Vth. The driving transistor DR is in the on state when the sampling step is advanced, and is turned off when an off condition (Vs−Vg)+Vth<0 is reached. Here, Vs−Vg is the gate-source voltage of the driving transistor DR and is a difference voltage between the voltage Vs on the second node n2 and the voltage on the first node n1. When the driving transistor DR is turned off, a threshold voltage Vth of the driving transistor DR is sampled and stored in the first capacitor Cst. In the sampling step, the voltage on the fourth node n4 is the data voltage Vdata.

In the holding step, the voltage of each of the first scan signal SCAN1, the second scan signal SCAN2, and the EM signal EM is the gate-off voltage. In the holding step, since the first to sixth switch transistors M1 to M6 are in the off state, the second to fourth nodes n2, n3, and n4 are floated.

In the light emission step, the voltage of the EM signal EM is the gate-on voltage, and the voltage of each of the first scan signal SCAN1 and the second scan signal SCAN2 is the gate-off voltage. In the light emission step, while the first and third switch transistors M1 and M3 are turned on, other switch transistors M2, M4, M5, and M6 are in the off state. In the light emission step, the driving transistor DR generates a current according to the gate-source voltage Vgs to drive the light-emitting element LD. The light-emitting element LD may emit light with the current from the driving transistor DR in the light emission step.

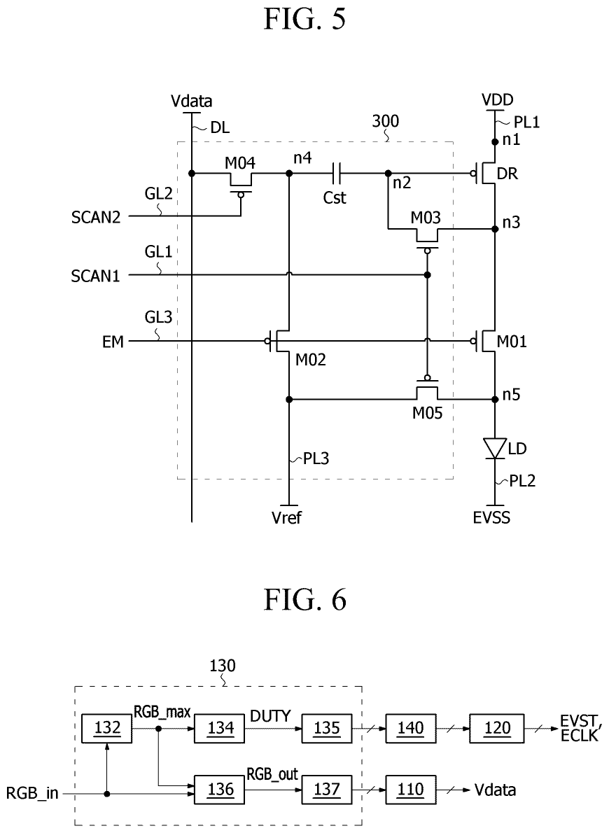

FIG. 5 is a circuit diagram illustrating another example of a pixel circuit that can be applied to the display device according to the embodiment of the present disclosure. In this embodiment, redundant description with the pixel circuit illustrated in FIG. 4 described above will not be repeated.

Referring to FIG. 5, the pixel circuit includes a driving transistor DR, a first switch transistor M01, and a compensation circuit 300. The compensation circuit 300 includes second to fifth switch transistors M02 to M05 and a capacitor Cst. The compensation circuit 300 compensates a gate voltage of the driving transistor DR by a threshold voltage of the driving transistor DR by sampling the threshold voltage of the driving transistor DR. The transistors DR and M01 to M05 may be implemented by p-channel transistors, but the present disclosure is not limited thereto.

The driving transistor DR includes a first electrode connected to a first node n1, a gate electrode connected to a second node n2, and a second electrode connected to a third node n3. A pixel driving voltage EVDD is applied to the first power line PL1 connected to the first node n1. A light-emitting element LD has an anode electrode connected to a fifth node n5 and a cathode electrode connected to the second power line PL2 to which the ground voltage EVSS is applied. The capacitor Cst is connected between the second node n2 and a fourth node n4.

The first switch transistor M01 is turned on in response to the gate-on voltage of the EM signal EM. A gate electrode of the first switch transistor M01 is connected to the third gate line GL3. A first electrode of the first switch transistor M01 is connected to the third node n3, and a second electrode of the first switch transistor M01 is connected to the fifth node n5.

The second switch transistor M02 is turned on in response to the gate-on voltage of the EM signal EM to supply the reference voltage Vref to the fourth node n4. The second switch transistor M02 includes a first electrode connected to the fourth node n4, a gate electrode connected to the third gate line GL3, and a second electrode connected to the third power line PL3 to which the reference voltage Vref is applied.

The third switch transistor M03 is turned on in response to the gate-on voltage of the first scan signal SCAN1 to electrically connect the third node n3 to the second node n2. The third switch transistor M03 includes a first electrode connected to the second node n2, a gate electrode connected to the first gate line GL1, and a second electrode connected to the third node n3.

The fourth switch transistor M04 is turned on in response to the gate-on voltage of the second scan signal SCAN2 to supply the data voltage Vdata to the fourth node n4. The fourth switch transistor M04 includes a first electrode connected to the data line DL, a gate electrode connected to the second gate line GL2, and a second electrode connected to the fourth node n4.

The fifth switch transistor M05 is turned on in response to the gate-on voltage of the first scan signal SCAN1 to supply the reference voltage Vref to the fifth node n5. The fifth switch transistor M05 includes a first electrode connected to the third power line PL3, a gate electrode connected to the first gate line GL1, and a second electrode connected to the fifth node n5.

A pixel control method according to the embodiment of the present disclosure sets a grayscale value of pixel data to be written to a brightest pixel, that is, a pixel with maximum luminance, among all pixels of the display panel as a maximum grayscale value, and sets light emission periods of pixels. If the grayscale value of pixel data is set as the maximum grayscale value with the pixel with the maximum luminance among all pixels as a reference, the data voltage Vdata becomes high even at a grayscale below a high grayscale. For this reason, since the current density of the light-emitting element LD becomes high, the problem of shift of color coordinates can be improved, and light emission efficiency can be improved. With the pixel control method according to the embodiment of the present disclosure, the data voltage Vdata varies depending on the grayscale of the pixel data under maximum grayscale setting conditions as described above, and the lighting period of the pixel varies depending on the grayscale of the pixel data in one frame period.

The grayscale value of the pixel with the maximum luminance among all pixels of the display panel may be different depending on the input image. For example, the grayscale value of the pixel data to be written to the pixel with the maximum luminance in a dark image may be a low grayscale, and the grayscale value of the pixel data to be written to the pixel with the maximum luminance in a bright image may be the maximum grayscale value.

The timing controller 130 may include a pixel controller for realizing the pixel control method as described above. FIG. 6 is a block diagram illustrating a pixel controller according to a first embodiment of the present disclosure.

Referring to FIG. 6, the pixel controller includes a maximum grayscale detector 132, a duty calculator 134, a gate controller 135, a pixel data converter 136, and a pixel data transmitter 137.

Pixel data RGB_in of an input image is input to the maximum grayscale detector 132 and the pixel data converter 136. The timing controller 130 may execute image processing on the pixel data of the input image received from the host system 200 on the basis of an optical compensation algorithm and an image quality improvement algorithm set in advance, and then, may input the pixel data to the maximum grayscale detector 132.

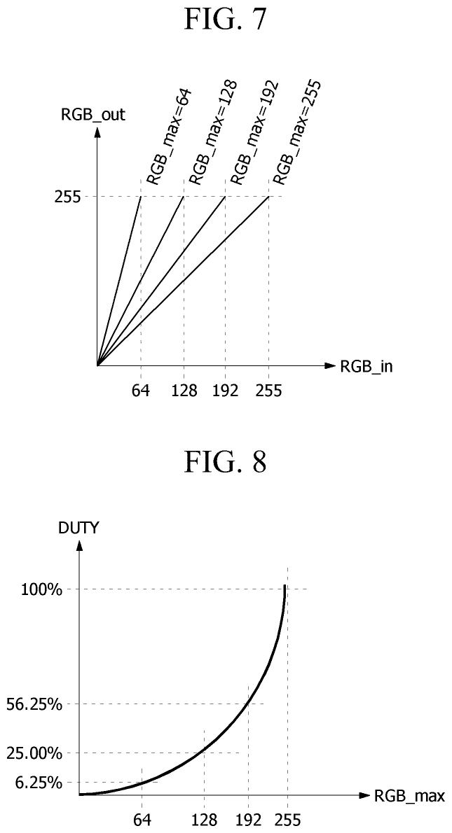

The maximum grayscale detector 132 sets a maximum grayscale value among grayscale values of the pixel data RGB_in of one frame data for each frame period as a maximum input grayscale RGB_max and provides the maximum input grayscale RGB_max to the duty calculator 134 and the pixel data converter 136. Since a highest grayscale value in the pixel data included in one-frame data is selected as the maximum input grayscale RGB_max, the maximum input grayscale RGB_max may vary depending on a grayscale distribution (e.g., a maximum grayscale value) of the input image. For example, as illustrated in FIG. 7, the maximum input grayscale RGB_max may vary to the grayscale 64, the grayscale 128, the grayscale 192, the grayscale 255, and the like.

The maximum input grayscale RGB_max is a grayscale value of variable input pixel data. A maximum grayscale (hereinafter, referred to as a “maximum output grayscale”) of pixel data RGB_out to be output from the timing controller 130 is a grayscale value having a value determined according to the number of bits of the pixel data. The maximum output grayscale is a maximum grayscale value determined according to the number of bits of the pixel data. For example, the maximum grayscale value in eight-bit pixel data is 255. In the eight-bit pixel data, a low grayscale range may include grayscales 0 (zero) to 64, and a middle grayscale range may include grayscales 65 to 192. The grayscale 0 may be a black grayscale value. When the data voltage Vdata of the black grayscale is applied to the pixel circuit, since no current flows in the light-emitting element LD, the corresponding pixel looks black. A high grayscale range may include grayscales 193 to 255. The grayscale 255 may be a white grayscale value. When the data voltage Vdata of the white grayscale is applied to the pixel circuit, the amount of current flowing in the light-emitting element LD becomes maximum, and the light-emitting element LD of the corresponding pixel is turned on with a maximum luminance.

As illustrated in FIG. 7, the pixel data converter 136 matches the maximum input grayscale RGB_max with the maximum output grayscale for each frame and stretches an input grayscale range to match input grayscales equal to or smaller than the maximum input grayscale RGB_max with output grayscales lower than the maximum output grayscale. An input grayscale value equal to or smaller than maximum input grayscale RGB_max is lowered to a grayscale value equal to or smaller than the maximum output grayscale. As an input grayscale value is lowered, an output grayscale value may be lowered linearly or nonlinearly.

The pixel data RGB_out output from the pixel data converter 136 is transmitted to the data driver 110 via the pixel data transmitter 137. The pixel data converter 136 may convert a clock training pattern or preamble and a control data packet into a differential signal according to a communication protocol set in advance and transmit the differential signal to the data driver 110. Then, the pixel data converter 136 may encode the pixel data RGB_out in a form of a data packet, convert the data packet into a differential signal, and transmit the differential signal to the data driver 110. The data voltage Vdata output from the data driver 110 may be different depending on the grayscale of the pixel data RGB_out output from the timing controller 130 or a gamma reference voltage. For example, in the case of positive gamma compensation, as the grayscale value of the pixel data RGB_out is higher, a voltage level of the data voltage Vdata may be higher. In the case of inverse gamma compensation, as the grayscale value of the pixel data RGB_out is higher, the voltage level of the data voltage Vdata may be lower.

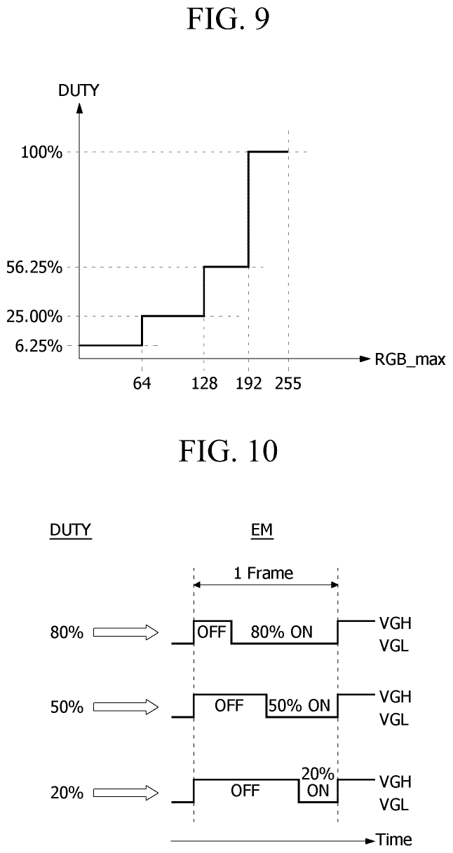

As illustrated in FIGS. 8 and 9, the duty calculator 134 sets duty data DUTY corresponding to the maximum input grayscale RGB_max for each frame. The duty data controls a maximum lighting period of a pixel. The duty data DUTY includes duty ratio information of the start pulses and the clocks that are input to the gate driver 120. The duty ratio of the gate signal applied to pixels to which the pixel data is written, for example, the EM signal EM is determined according to the duty ratio of the start pulse and the clock that are input to the gate driver 120. The timing controller 130 can control the duty ratios of the gate signals SCAN1, SCAN2, and EM that are output from the gate driver 120, using the duty data DUTY.

The greater the duty ratio of the EM signal EM, the longer a gate-on voltage period of the EM signal EM becomes and the longer the lighting period of the pixel becomes. The duty calculator 134 reduces the value of the duty data DUTY to decrease the maximum lighting period of the pixel as the maximum input grayscale RGB_max is lower. As illustrated in FIG. 8, the lower the grayscale of the input pixel data in a range equal to or smaller than the maximum input grayscale RGB_max, the lower the duty data DUTY, and the further the lighting period of the pixel may be decreased. Accordingly, the lighting period of the pixels indicated by the duty data DUTY varies depending on the maximum input grayscale RGB_max. A light emission time of the pixels is decreased when a duty ratio of the duty data DUTY is decreased.

The gate controller 135 outputs a gate timing control signal including the start pulse of the EM signal EM and clock timing information in response to the duty data DUTY output from the duty calculator 134. The gate controller 135 outputs a gate timing control signal including start pulses of first and second scan pulses and clock timing information according to a register set value of a scan pulse set in advance. The gate timing control signal output from the gate controller 135 is converted into a signal that swings between the gate-on voltage and the gate-off voltage, via the level shifter 140 and is transmitted to the gate driver 120. The gate driver 120 outputs gate signals in response to the start pulses and the clock signal input via the level shifter 140. When the duty ratio of the start pulse and the clock signal is changed, the duty ratios of the gate signals that are output from the gate driver 120 may be changed.

FIG. 7 is a diagram illustrating grayscale conversion of input pixel data in the timing controller. In FIG. 7, the horizontal axis is a grayscale of input pixel data RGB_in and the vertical axis is a grayscale of output pixel data RGB_out.

Referring to FIG. 7, the pixel data converter 136 converts the maximum input grayscale RGB_max into a maximum output grayscale value, and converts input grayscales equal to or smaller than the maximum input grayscale RGB_max into corresponding grayscale values in an entire grayscale range of an output grayscale 0 (zero) to a maximum output grayscale 255 through data stretching. For example, when one-frame data includes pixel data of low grayscales 0 to 64, the maximum input grayscale RGB_max is 64. The maximum input grayscale 64 is converted into the maximum output grayscale 255. In this case, as the input grayscale is smaller, the output grayscale value is decreased within the output grayscales 0 to 255.

When one-frame data includes pixel data of grayscales 0 to 128, the maximum input grayscale RGB_max is 128. The maximum input grayscale 128 is converted into the maximum output grayscale 255, and the input grayscales 0 to 128 are converted into corresponding grayscale values in the output grayscales 0 to 255. In this case, as the input grayscale is smaller, the output grayscale vale is decreased.

When one-frame data includes pixel data of grayscales 0 to 255, the maximum input grayscale RGB_max is 255. The maximum input grayscale 255 is the maximum output grayscale 255, and the input grayscales 0 to 255 are selected as corresponding grayscale values in the output grayscales 0 to 255. When one-frame data includes pixel data of grayscales 0 to 255, the input grayscale values may be selected as the output grayscale values directly without change.

FIGS. 8 and 9 are diagrams illustrating duty data that varies depending on the maximum input grayscale. In FIGS. 8 and 9, the horizontal axis is the maximum input grayscale RGB_max and the vertical axis is duty data DUTY. The duty data DUTY includes the duty ratio (%) of the EM signal EM. The duty ratio (%) of the EM signal EM determines a ratio of a lighting period and a light-off period of a pixel in one frame period. As the duty ratio (%) of the EM signal EM is lower, the lighting period of the pixel is decreased in one frame period.

Referring to FIG. 8, the duty calculator 134 calculates a PWM duty ratio controlling the lighting period of the pixel from the maximum input grayscale RGB_max and outputs the duty data DUTY. A PWM duty ratio (%) of the maximum input grayscale RGB_max to the duty data DUTY may be determined in a form of a linear straight line or a nonlinear curve.

For example, the duty calculator 134 may determine a maximum value of the PWM duty ratio to 6.25% when the maximum input grayscale RGB_max is 64. In this case, the maximum value of the PWM duty ratio may be determined with the duty ratio 6.25% of a start pulse EVST and a clock ECLK that are input to the third gate driver 123 illustrated in FIG. 3, as a reference and the duty ratio of the EM signals EM that are applied to the pixels may be limited to 6.25% or less. When the maximum input grayscale RGB_max is 0 to 63 smaller than 64, the maximum value of the PWM duty ratio may be gradually decreased to a value smaller than 6.25%.

The duty calculator 134 may determine the maximum value of the PWM duty ratio to 25% when the maximum input grayscale RGB_max is 128. In this case, the duty ratio of the EM signal EM may be limited to 25% or less. When the maximum input grayscale RGB_max belongs to a grayscale range of 65 to 127, the maximum value of the PWM duty ratio may be decreased in a range greater than 6.25% and smaller than 25% as the maximum input grayscale RGB_max is smaller.

The duty calculator 134 may determine the maximum value of the PWM duty ratio to 56.25% when the maximum input grayscale RGB_max is 192. In this case, the duty ratio of the EM signal EM may be limited to 56.25% or less. When the maximum input grayscale RGB_max belongs to a grayscale range of 129 to 191, the maximum value of the PWM duty ratio may be decreased in a range greater than 25% and smaller than 56.25% as the maximum input grayscale RGB_max is smaller.

The duty calculator 134 may determine the maximum value of the PWM duty ratio to 100% when the maximum input grayscale RGB_max is 255. In this case, the duty ratio of the EM signal EM may be limited to 100% or less. When the maximum input grayscale RGB_max belongs to a grayscale range of 129 to 254, the maximum value of the PWM duty ratio may be decreased in a range greater than 25% and smaller than 100% as the maximum input grayscale RGB_max is smaller.

Referring to FIG. 9, the maximum input grayscale RGB_max may be divided into a plurality of sections, and the PWM duty ratio (%) may be selected by maximum input grayscale section in stages or in a stepwise manner. In this case, the circuit configuration of the duty calculator 134 may be implemented small and efficiently. For the optimization of a low grayscale range in contrast to the number of sections of the maximum input grayscale RGB_max, the maximum input grayscale sections may be applied nonlinearly.

For example, the duty calculator 134 may determine the PWM duty ratio to 6.25% when the maximum input grayscale RGB_max is 0 to 64. When frame data with the maximum input grayscale RGB_max of 64 or less is input to the timing controller 130, the duty ratio of the EM signal EM may be determined to 6.25%.

When the maximum input grayscale RGB_max is 65 to 128, the duty calculator 134 may determine the PWM duty ratio to 25%. When frame data with the maximum input grayscale RGB_max having a grayscale value of 65 to 128 is input to the timing controller 130, the duty ratio of the EM signal EM may be determined to 25%. When the maximum input grayscale RGB_max is 129 to 192, the duty calculator 134 may determine the PWM duty ratio to 56.25%. When frame data with the maximum input grayscale RGB_max having a grayscale value of 129 to 192 is input to the timing controller 130, the duty ratio of the EM signal EM may be determined to 56.25%. When the maximum input grayscale RGB_max is 193 to 255, the duty calculator 134 may determine the PWM duty ratio to 100%. When frame data with the maximum input grayscale RGB_max having a grayscale value of 193 to 255 is input to the timing controller 130, the duty ratio of the EM signal EM may be determined to 100%.

FIG. 10 is a diagram illustrating an example where a lighting period of a pixel varies depending on a duty ratio of an EM signal selected according to a maximum input grayscale. In FIG. 10, “ON” represents a lighting period of a pixel during which the light-emitting element LD emits light, and “OFF”represents a light-off period of a pixel.

Referring to FIG. 10, the timing controller 130 calculates the maximum input grayscale RGB_max by analyzing the pixel data of the input image and controls the duty ratio of the EM signal EM according to the maximum input grayscale RGB_max for each frame. The timing controller 130 may control the duty ratio of the EM signal EM using the duty data DUTY that varies depending on the maximum input grayscale RGB_max.

The light-emitting element LD of the pixel may emit light for a period during which the voltage of the EM signal EM is the gate-on voltage VGL. When the voltage of the EM signal EM is the gate-off voltage VGH, the current flowing into the light-emitting element LD may be blocked and the light-emitting element LD may be turned off. Accordingly, the lighting period of the pixels is proportional to the gate-on voltage period of the EM signal EM.

When the duty ratio indicated by the duty data DUTY is 80%, the gate-on voltage period ON of the EM signal EM is 80%. When the duty ratio indicated by the duty data DUTY is 20%, the gate-on voltage period ON of the EM signal EM is 20%. The lighting period of the pixel is proportional to the gate-on voltage period ON of the EM signal EM.

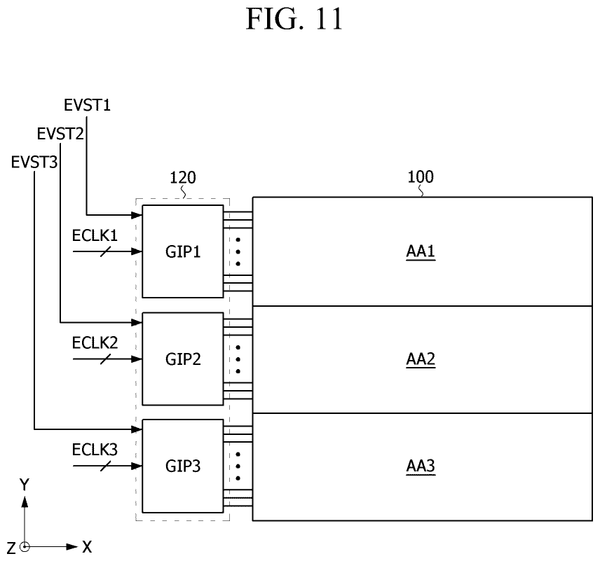

The timing controller 130 may vary the voltage level of the data voltage Vdata according to the maximum input grayscale RGB_max by divided area in the display area AA, and may vary the duty ratio of the EM signal EM by divided area in the display area AA as illustrated in FIGS. 11 to 14.

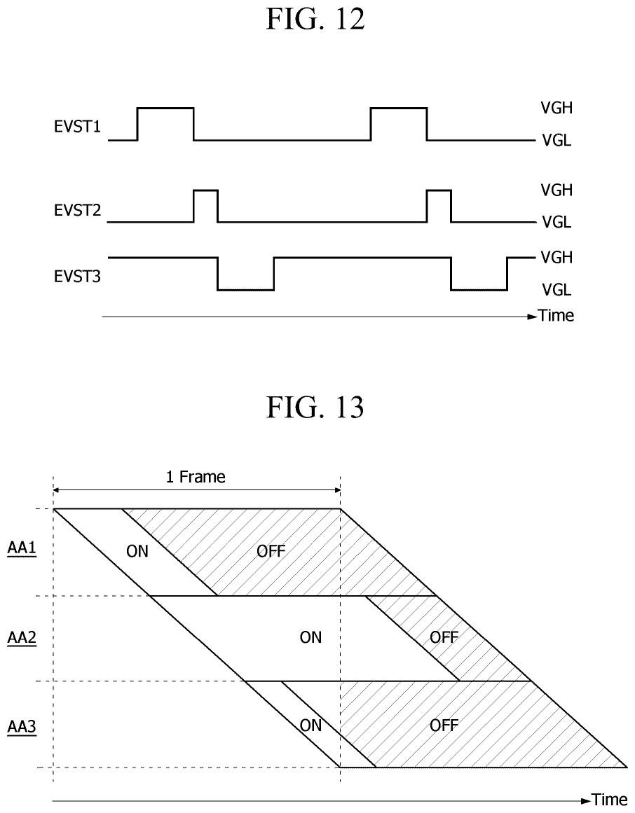

FIG. 11 is a diagram illustrating an example of display areas where lighting periods of pixels are controlled independently. FIG. 12 is a waveform chart illustrating an example of EM start pulses illustrated in FIG. 11. FIG. 13 is a diagram illustrating an example where lighting periods of pixels are controlled differently between the display areas illustrated in FIG. 11. In FIG. 13, “ON” represents a lighting period of a pixel, and “OFF” represents a light-off period of a pixel.

Referring to FIGS. 11 to 13, the display area AA may be divided into first to third display areas AA1, AA2, and AA3 divided along the Y-axis direction.

The gate driver 120 may include a first EM driver GIP1 for supplying the EM signal EM to pixels provided in the first display area AA1, a second EM driver GIP2 for supplying the EM signal EM to pixels provided in the second display area AA2, and a third EM driver GIP3 for supplying the EM signal EM to pixels provided in the third display area AA3.

The timing controller 130 may calculate a first maximum input grayscale from pixel data to be written to the pixels in the first display area AA1 for each frame and may control the duty ratio of the EM signal EM that is applied to the pixels in the first display area AA1, on the basis of the first maximum input grayscale. For example, the timing controller 130 may select a maximum grayscale value among grayscale values of pixel data to be written to the pixels in the first display area AA1 as a first maximum input grayscale and output first duty data selected according to the first maximum input grayscale. The first EM driver GIP1 may receive a start pulse EVST1 and a clock signal ECLK1 as input and supply an EM signal EM to pixels provided in the first display area AA1. Duty ratios of a start pulse EVST1 and a clock signal ECLK1 that are input to the first EM driver GIP1 may vary depending on the first maximum input grayscale. The first duty data may include duty ratio information of the start pulse EVST1 and the clock signal ECLK1. When the duty ratios of the start pulse EVST1 and the clock signal ECLK1 are changed, the duty ratio of the EM signal EM that is applied to the pixels in the first display area AA1 is changed. For example, the duty ratio of the EM signal EM that is applied to the pixels in the first display area AA1 may be changed in proportion to the duty ratios of the start pulse EVST1 and the clock signal ECLK1. As a result, while the higher the first maximum input grayscale, the longer the lighting period of the pixels provided in the first display area AA1, as the first maximum input grayscale is lower, the lighting period of the pixels provided in the first display area AA1 may be decreased.

The timing controller 130 may calculate a second maximum input grayscale from pixel data to be written to the pixels in the second display area AA2 for each frame and may control the duty ratio of the EM signal EM that is applied to the pixels in the second display area AA2, on the basis of the second maximum input grayscale. For example, the timing controller 130 may select a maximum grayscale value among grayscale values of pixel data to be written to the pixels in the second display area AA2 as a second maximum input grayscale and output second duty data selected according to the second maximum input grayscale. The Second EM driver GIP2 may receive a start pulse EVST2 and a clock signal ECLK2 as input and supply an EM signal EM to pixels provided in the second display area AA1. Duty ratios of the start pulse EVST2 and a clock signal ECLK2 that are input to the second EM driver GIP2 may vary depending on the second maximum input grayscale. When the duty ratios of the start pulse EVST2 and the clock signal ECLK2 are changed, the duty ratio of the EM signal EM that is applied to the pixels in the second display area AA2 is changed. For example, the duty ratio of the EM signal EM that is applied to the pixels in the first display area AA2 may be changed in proportion to the duty ratios of the start pulse EVST2 and the clock signal ECLK2. As a result, while the higher the second maximum input grayscale, the longer the lighting period of the pixels provided in the second display area AA2, as the second maximum input grayscale is lower, the lighting period of the pixels provided in the second display area AA2 may be decreased.

The timing controller 130 may calculate a third maximum input grayscale from pixel data to be written to the pixels in the third display area AA3 for each frame and may control the duty ratio of the EM signal EM that is input to the pixels in the third display area AA3, on the basis of the third maximum input grayscale. For example, the timing controller 130 may select a maximum grayscale value among grayscale values of pixel data to be written to the pixels in the third display area AA3 as a third maximum input grayscale and output third duty data selected according to the third maximum input grayscale. The third EM driver GIP3 may receive a start pulse EVST3 and a clock signal ECLK3 as input and supply an EM signal EM to pixels provided in the third display area AA3. Duty ratios of a start pulse EVST3 and a clock signal ECLK3 that are input to the third EM driver GIP3 may vary depending on the third maximum input grayscale. The third duty data may include duty ratio information of the start pulse EVST3 and the clock signal ECLK3. When the duty ratios of the start pulse EVST3 and the clock signal ECLK3 are changed, the duty ratio of the EM signal EM that is applied to the pixels in the third display area AA3 is changed. For example, the duty ratio of the EM signal EM that is applied to the pixels in the first display area AA3 may be changed in proportion to the duty ratios of the start pulse EVST3 and the clock signal ECLK3. As a result, while the higher the third maximum input grayscale, the longer the lighting period of the pixels provided in the third display area AA3, as the third maximum input grayscale is lower, the lighting period of the pixels provided in the third display area AA3 may be decreased.

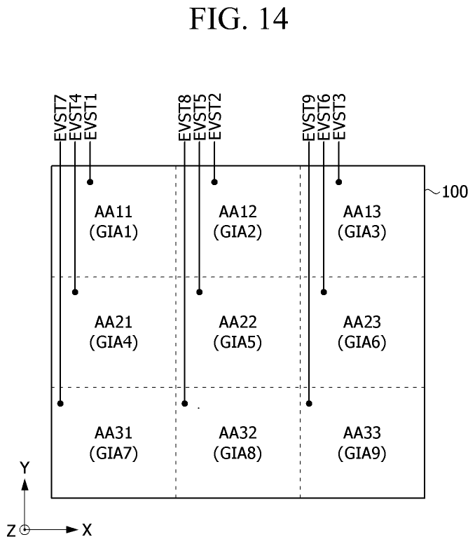

FIG. 14 is a diagram illustrating another example of display areas where lighting periods of pixels are controlled independently. In FIG. 14, the clock signal that is input to the EM drivers provided in the display areas is omitted. In this embodiment, redundant description with the embodiment illustrated in FIGS. 11 to 13 described above will not be repeated.

Referring to FIG. 14, the display area AA may be divided into first to ninth display areas AA11 to AA33 divided along the X-axis direction and the Y-axis direction.

The gate driver 120 may be divided by divided display area and may be provided in the display areas AA11 to AA33. For example, a first EM driver GIA1 may be provided in the first display area AA11 to supply the EM signal EM to pixels in the first display area AA11. A second EM driver GIA2 may be provided in the second display area AA12 to supply the EM signal EM to pixels in the second display area AA12. A third EM driver GIA3 may be provided in the third display area AA13 to supply the EM signal EM to pixels in the third display area AA13. An eighth EM driver GIA8 may be provided in the eighth display area AA32 to supply the EM signal EM to pixels in the eighth display area AA32. A ninth EM driver GIA9 may be provided in the ninth display area AA33 to supply the EM signal EM to pixels in the ninth display area AA33. Start pulses EVST1 to EVST9 divided by display area and clock signals may be input to the EM drivers GIA1 to GIA9, respectively.

The timing controller 130 may calculate a maximum input grayscale RGB_max by display area for each frame and may vary the duty ratio of the EM signal by display area on the basis of the maximum input grayscale RGB_max. For example, the timing controller 130 may calculate a first maximum input grayscale from pixel data to be written to pixels in the first display area AA11 for each frame period and may control the duty ratio of the EM signal EM that is applied to the pixels in the first display area AA11, on the basis of the first maximum input grayscale. The timing controller 130 may calculate a ninth maximum input grayscale from pixel data to be written to pixels in the ninth display area AA33 for each frame and may control the duty ratio of the EM signal EM that is applied to the pixels in the ninth display area AA33, on the basis of the ninth maximum input grayscale.

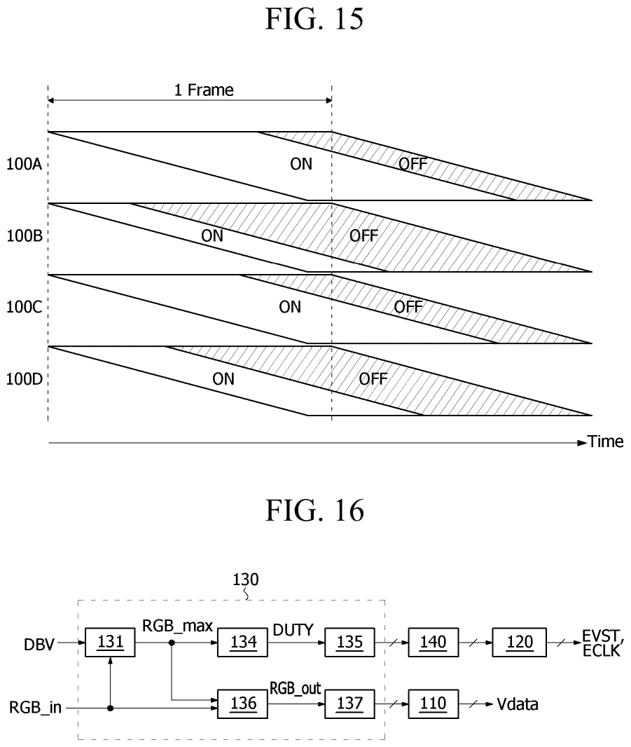

FIG. 15 is a diagram illustrating an example where lighting periods of pixels are controlled independently by display panel in the tiled display device. In this embodiment, redundant description with the embodiment illustrated in FIGS. 11 to 14 described above will not be repeated. In FIG. 15, “ON” represents a lighting period of a pixel, and “OFF” represents a light-off period of a pixel.

Referring to FIGS. 2 and 15, the tiled display device may include first to fourth display panels 100A to 100D. The gate driver 120 may be divided by display panel and may be provided in the display areas AA of the display panels 100A to 100D. For example, the first display panel 100A includes a gate driver 120 provided in a display area AA, and the second display panel 100 B includes a gate driver 120 provided in a display area AA. The gate driver of the first display panel 100A includes a EM driver for receiving a first start pulse and a first clock as input and supply a first EM signal to pixels provided in the display area AA of the first display panel 100A, and the gate driver of the second display panel 100B includes a EM driver for receive a second start pulse and a second clock as input and supply a second EM signal to pixels provided in the display area AA of the second display panel 100B. The timing controller 130 may select a maximum grayscale value among grayscale values of pixel data to be written to the pixels in the first display panel 100A as a first maximum input grayscale and output first duty data selected according to the first maximum input grayscale, and select a maximum grayscale value among grayscale values of pixel data to be written to the pixels in the second display panel 100B as a second maximum input grayscale and output second duty data selected according to the second maximum input grayscale The first duty data includes duty ratio information of the first start pulse and the first clock, and the second duty data includes duty ratio information of the second start pulse and the second clock. A duty ratio of the first EM signal changes in proportion to duty ratios of the first start pulse and the first clock, and a duty ratio of the second EM signal changes in proportion to duty ratios of the second start pulse and the second clock.

The timing controller 130 may calculate a maximum input grayscale RGB_max by display panel for each frame and may vary the duty ratio of the EM signal by display panel on the basis of the maximum input grayscale RGB_max. For example, the timing controller 130 may calculate a first maximum input grayscale from pixel data to be written to pixels in the first display panel 100A for each frame period and may control the duty ratio of the EM signal EM that is applied to the pixels in the first display panel 100A, on the basis of the first maximum input grayscale. The timing controller 130 may calculate a second maximum input grayscale from pixel data to be written to pixels in the second display panel 100B for each frame period and may control the duty ratio of the EM signal EM that is applied to the pixels in the second display panel 100B, on the basis of the second maximum input grayscale. The timing controller 130 may calculate a fourth maximum input grayscale from pixel data to be written to pixels in the fourth display panel 100D for each frame and may control the duty ratio of the EM signal EM that is applied to the pixels in the fourth display panel 100D, on the basis of the fourth maximum input grayscale.

The timing controller 130 may adjust the maximum input grayscale RGB_max in conjunction with a digital brightness value (hereinafter, referred to as “DBV”) received from the host system 200. The host system 200 may output the DBV that varies depending on user input data received via a user interface or depending on illuminance of an ambient environment. The DBV limits the maximum luminance of the display panel. For example, while the maximum luminance of the pixels may increase when the DBV becomes high, the maximum luminance of the pixels may fall when the DBV becomes low.

FIG. 16 is a block diagram illustrating a pixel controller according to a second of the present disclosure. In this embodiment, redundant description with the embodiment illustrated in FIG. 6 will not be repeated.

Referring to FIG. 16, the pixel controller includes a maximum grayscale detector 131, a duty calculator 134, a gate controller 135, a pixel data converter 136, and a pixel data transmitter 137.

Pixel data RGB_in of an input image is input to the maximum grayscale detector 131 and the pixel data converter 136. The maximum grayscale detector 131 receives a DBV signal as input. The maximum grayscale detector 132 calculates a maximum input grayscale RGB_max for each frame period, but varies the maximum input grayscale RGB_max depending on the DBV. For example, when the DBV is equal to or smaller than a predetermined reference value, the maximum input grayscale RGB_max becomes low, and the lower the DBV, the lower the maximum input grayscale RGB_max may become. The maximum input grayscale RGB_max output from the maximum grayscale detector 131 is provided to the duty calculator 134 and the pixel data converter 136.

The pixel data converter 136 sets the maximum input grayscale RGB_max as a maximum output grayscale for each frame and stretches input graduations equal to or smaller than the maximum input grayscale RGB_max to an output grayscale range equal to or smaller than the maximum output grayscale. As an input grayscale value is lower, an output grayscale value may be decreased linearly or nonlinearly.

Pixel data RGB_out that is output from the pixel data converter 136 is transmitted to the data driver 110 via the pixel data transmitter 137. The duty calculator 134 sets duty data DUTY corresponding to the maximum input grayscale RGB_max for each frame.

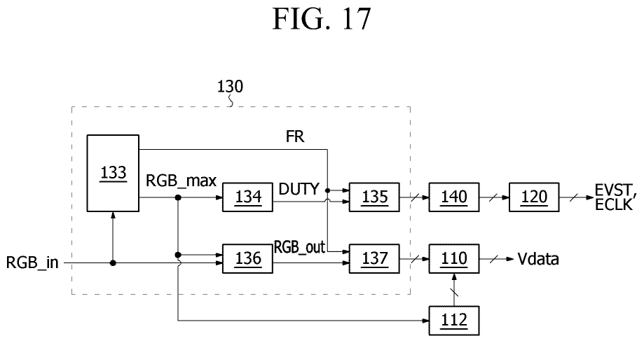

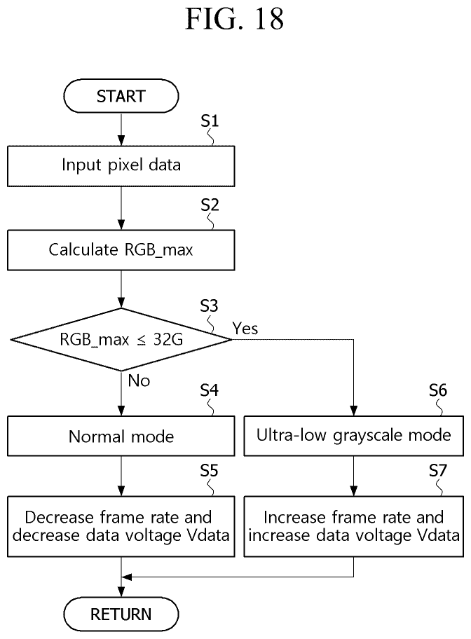

According to the present disclosure, it is possible to improve image quality at an ultra-low grayscale, in particular, the problem of shift of color coordinates by further improving the efficiency of the light-emitting element LD at the ultra-low grayscale. FIG. 17 is a block diagram illustrating a pixel controller according to a third embodiment of the present disclosure. FIG. 18 is a flowchart illustrating a pixel control method when an ultra-low grayscale mode is set. In this embodiment, redundant description with the above-described embodiments will not be repeated.

Referring to FIGS. 17 and 18, the pixel controller includes a maximum grayscale detector 133, a duty calculator 134, a gate controller 135, a pixel data converter 136, and a pixel data transmitter 137.

Pixel data of an input image is input to the maximum grayscale detector 133 and the pixel data converter 136 (S1). The maximum grayscale detector 132 calculates a maximum input grayscale RGB_max for each frame period and provides the maximum input grayscale RGB_max to the duty calculator 134, the pixel data converter 136, and a gamma reference voltage supplier 112 (S2).

The pixel data converter 136 sets the maximum input grayscale RGB_max as a maximum output grayscale for each frame and stretches input grayscales equal to or smaller than the maximum input grayscale RGB_max to an output grayscale range equal to or smaller than the maximum output grayscale. Pixel data RGB_out that is output from the pixel data converter 136 is transmitted to the data driver 110 via the pixel data transmitter 137. The duty calculator 134 sets duty data DUTY corresponding to the maximum input grayscale RGB_max for each frame.

In the pixel control method according to the embodiment of the present disclosure, In the pixel control method according to the embodiment of the present disclosure, the timing controller 130 may determine whether the maximum input grayscale RGB_max belongs to an ultra-low grayscale range relatively lower in a low grayscale range. The timing controller 130 may control the pixels in a normal mod when the maximum input grayscale belongs to a grayscale range outside the ultra-low grayscale range and control a frame rate to a reference frequency in the normal mod. The timing controller 130 may control the pixels in an ultra-low grayscale mode when the maximum input grayscale belongs to the ultra-low grayscale range, increase the frame rate to a frequency higher than the reference frequency in the ultra-low grayscale mode, and increase a data voltage that is output from the data driver. For example, The timing controller 130 controls the display panel driving circuit in the ultra-low grayscale mode when the maximum input grayscale RGB_max calculated from the maximum grayscale detector 133 is a grayscale equal to or smaller than the grayscale 32, and controls the display panel driving circuit in the normal mode when the maximum input grayscale RGB_max is greater than the grayscale 32 (S3 to S7). The maximum grayscale detector 133 of the timing controller 130 controls a frame rate FR to a reference frequency in the normal mode and decreases the voltage level of the data voltage Vdata (S3, S4, and S5). Meanwhile, the timing controller 130 increases the frame rate to a frequency higher than the reference frequency in the ultra-low grayscale mode and reduces the voltage level of the data voltage Vdata (S6 and S7). When the frame rate is low, the frame period becomes long, and when the frame rate is high, the frame period becomes short. A driving frequency of the display panel driving circuit is increased at an ultra-low grayscale. When the driving frequency of the display panel driving circuit is increased, the frequencies of the data voltage Vdata and the gate signals SCAN1, SCAN2, and EM are increased, and a driving frequency of a pixel is also increased.

The gate controller 135 and the pixel data transmitter 137 receive, as input, the frame rate FR that becomes higher in the ultra-low grayscale mode. The gate controller 135 outputs a gate timing control signal at a high frequency in response to the frame rate FR having a relatively high frequency in the ultra-low grayscale mode to increase a driving frequency of the gate driver 120. The pixel data transmitter 137 increases a transmission frequency of pixel data in response to the frame rate FR having the relatively high frequency in the ultra-low grayscale mode to increase the driving frequency of the data driver 110.

When the frame rate is 60 Hz in the normal mode, the frame rate may be 120 Hz in the ultra-low grayscale mode. When the frame rate is 120 Hz in the normal mode, the frame rate may be 240 Hz in the ultra-low grayscale mode.

The data driver 110 outputs the data voltage of the pixel data at a high voltage to the pixels in an odd-numbered frame period at the frame rate increased under the control of the timing controller 130 in the ultra-low grayscale mode. The gate driver 120 outputs the gate signals in the odd-numbered frame periods at the frame rate increased under the control of the timing controller 130 in the ultra-low grayscale mode. Accordingly, the pixel data is sequentially addressed to the pixels in the odd-numbered frame period in the ultra-low grayscale mode, and the pixel data is written to the pixels.

The timing controller 130 may transmit black grayscale data set regardless of the input image to the data driver 110 in the even-numbered frame period in the ultra-low grayscale mode. The data driver 110 may convert the black grayscale data set regardless of the input image into a black grayscale voltage and may output the black grayscale voltage to the pixels in the even-numbered frame period at the frame rate increased under the control of the timing controller 130 in the ultra-low grayscale mode. In another embodiment, the data driver 110 may generate black grayscale data and may convert the black grayscale data into the black grayscale voltage in an even-numbered frame period in the ultra-low grayscale mode.

In the ultra-low grayscale mode, the frame rate is increased, a frame period during which the black grayscale data is written is inserted, one frame period is reduced, and the lighting period of the pixels is shortened. When the data voltage Vdata is increased in the ultra-low grayscale mode, since a large current flows in the light-emitting elements of the pixels even at the ultra-low grayscale, and the turn-on time is shortened, it is possible to prevent shift of color coordinates.

The gate driver 120 outputs the gate signals in the odd-numbered frame period at the frame rate increased under the control of the timing controller 130 in the ultra-low grayscale mode. Accordingly, the pixel data is sequentially addressed to the pixels in the odd-numbered frame period in the ultra-low grayscale mode, and the pixel data is written to the pixels.

On the other hand, the ultra-low grayscale mode may be expanded and applied to an entire section in a low grayscale range.

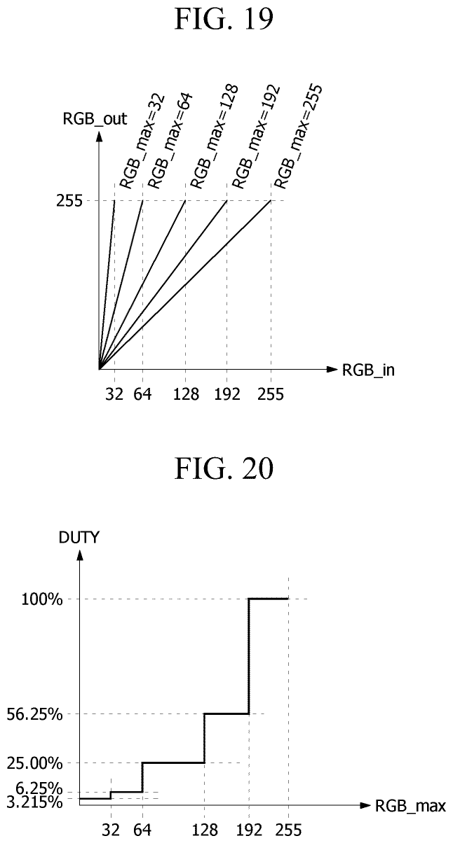

FIG. 19 is a diagram illustrating an input grayscale to an output grayscale in an ultra-low grayscale mode. In this embodiment, redundant description with the embodiment illustrated in FIG. 7 will not be repeated.

Referring to FIG. 19, in eight-bit pixel data, a low grayscale range may include grayscales 0 to 64. A low grayscale range relatively lower from the grayscale 0 in the low grayscale range may be set as an ultra-low grayscale range. For example, an ultra-low grayscale range may be set to a grayscale range of 0 to 32 relatively lower in a low grayscale range of 0 to 64 and may be controlled in a separate ultra-low grayscale mode. The remaining grayscales 33 to 255 including middle grayscales and high grayscales may be controlled in the normal mode.

The pixel data converter 136 of the timing controller 130 converts the maximum input grayscale RGB_max into the maximum output grayscale value for each frame period, and converts input grayscales equal to or smaller than the maximum input grayscale RGB_max into corresponding grayscale values in the entire grayscale range of 0 to 255 to generate output grayscales. For example, when one-frame data includes only pixel data having grayscales equal to or smaller than the ultra-low grayscale 32, the maximum input grayscale RGB_max is 32. The maximum input grayscale 32 is converted into the maximum output grayscale 255, and the grayscales equal to or smaller than the maximum input grayscale 32 are converted into output grayscales 0 to 255. In this case, as the input grayscale is smaller, the output grayscale value is decreased.

When one-frame data includes pixel data of grayscales 0 to 64, the maximum input grayscale RGB_max is 64. The maximum input grayscale 64 is converted into the maximum output grayscale 255, and the input grayscales 0 to 64 are converted into corresponding grayscale values in the output grayscales 0 to 255. When one-frame data includes pixel data of grayscales 0 to 128, the maximum input grayscale RGB_max is 128. The maximum input grayscale 128 is converted into the maximum output grayscale 255, the input grayscales 0 to 128 are converted into corresponding grayscale values in the output grayscales 0 to 255. When one-frame data includes pixel data of grayscales 0 to 255, the maximum input grayscale RGB_max is 255. The maximum input grayscale 255 is the maximum output grayscale 255, and the input grayscales 0 to 255 are selected as corresponding grayscale values in the output grayscales 0 to 255.

FIG. 20 is a diagram illustrating pixel data that varies depending on a maximum input grayscale in an ultra-low grayscale mode. In this embodiment, redundant description with the embodiment illustrated in FIGS. 8 and 9 will not be repeated.

Referring to FIG. 20, the duty calculator 134 of the timing controller 130 calculates a PWM duty ratio controlling the lighting period of the pixels from the maximum input grayscale RGB_max and outputs duty data DUTY. A PWM duty ratio (%) of the maximum input grayscale RGB_max to the duty data DUTY may be determined in a form of a linear straight line, a nonlinear curve, or a step. Accordingly, the EM signal may change in a form of any one of linear, nonlinear, and stepwise depending on the maximum input grayscale RGB_max.

The duty calculator 134 may determine a maximum value of the PWM duty ratio to a duty ratio of 3.125% or less when the maximum input grayscale RGB_max is equal to or smaller than the ultra-low grayscale 32. When the maximum input grayscale RGB_max is 64 or less, the PWM duty ratio may be determined to a duty ratio higher than 3.125% and equal to or lower than 6.25%. When the maximum input grayscale RGB_max is 128 or less, the PWM duty ratio may be determined to a duty ratio higher than 6.25% and equal to or lower than 25%. When the maximum input grayscale RGB_max is 192 or less, the PWM duty ratio may be determined to a duty ratio higher than 25% and equal to or lower than 56.25%. When the maximum input grayscale RGB_max is 255 or less, the PWM duty ratio may be determined to a duty ratio higher than 56.25% and equal to or lower than 100%.

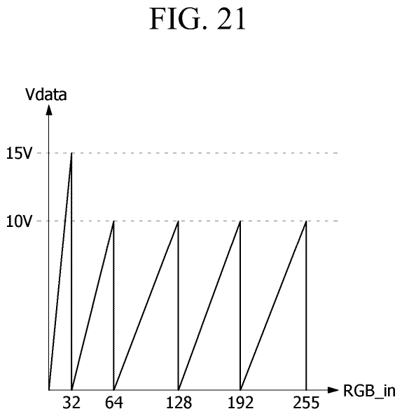

To increase the efficiency of the light-emitting element ED in the ultra-low grayscale mode, the timing controller 130 may further increase the data voltage Vdata. For example, when the maximum input grayscale RGB_max is a grayscale value belonging to a control range of the ultra-low grayscale mode, the timing controller 130 may increase the data voltage Vdata by increasing the gamma reference voltage that is output from the gamma reference voltage supplier 112. As a result, the data voltage Vdata may be increased at an ultra-low grayscale as illustrated in FIG. 21.

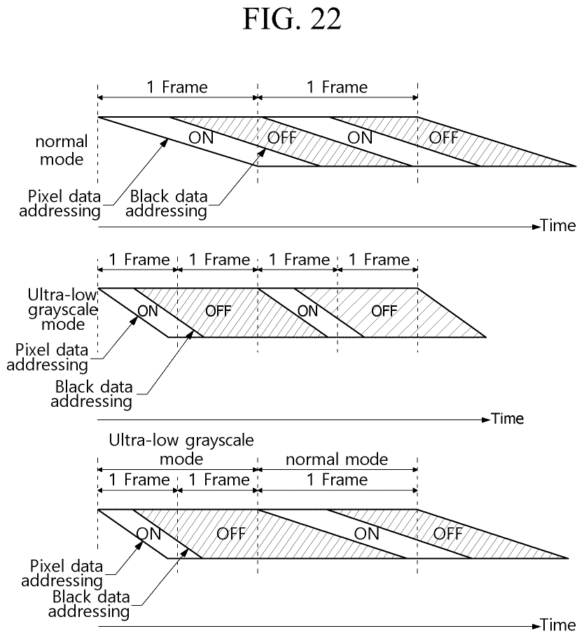

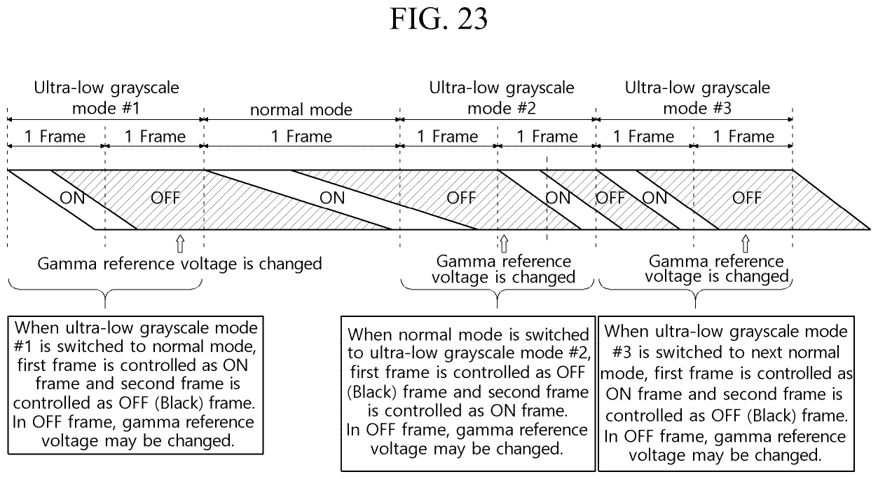

FIGS. 22 and 23 are drawings illustrating a difference in frame rate between an ultra-low grayscale mode and a normal mode. In FIGS. 22 and 23, “ON” represents a lighting period of pixels that are shifted along a scanning direction of pixel lines when pixel data is written to the pixels. “OFF” represents a turn-off of pixels that are shifted along a scanning direction of pixel lines when black grayscale data is written to the pixels.

Referring to FIGS. 22 and 23, to reduce power consumption, in the normal mode, the frame rate is set to the reference frequency and the driving frequency of the display panel driving circuit is also set with the reference frequency as a reference. In the normal mode, a frame period during which pixel data is written and a frame period during which black grayscale data is written are long according to a comparatively low frame rate. In the normal mode, the driving frequency of the display panel driving circuit is comparatively low. Accordingly, in the normal mode, an addressing period of pixel data and an addressing period of black data are comparatively long.

In contrast, in the ultra-low grayscale mode, a frame period during which pixel data is written and a frame period during which black grayscale data is written are shortened according to the frame rate higher than the reference frequency. In the ultra-low grayscale mode, when the frame rate is increased two times, the frame period is reduced to half compared to the normal mode. In the ultra-low grayscale mode, the driving frequency of the display panel driving circuit becomes faster than in the normal mode. In the ultra-low grayscale mode, when the frame rate is increased two times, the driving frequency of the display panel driving circuit may also be increased two times. Accordingly, in the ultra-low grayscale mode, an addressing period of pixel data and an addressing period of black data are comparatively long. In the ultra-low grayscale mode, the gamma reference voltage that is applied to the data driver 110 may be increased.

In the pixel control method according to the embodiment of the present disclosure, the timing controller 130 may add an off-frame period during which black grayscale data set regardless of pixel data in an input image is written to pixels, in the ultra-low grayscale mode. For example, as illustrated in FIG. 23, preferably, to prevent change in luminance of the pixels from being visible when the gamma reference voltage is changed, the gamma reference voltage is changed in the frame period during which black grayscale data is applied. For example, when the ultra-low grayscale mode is switched to the normal mode, a first frame period of the ultra-low grayscale mode is controlled as an ON frame period, and a second frame period is controlled as an OFF (Black) frame period during which the pixels are turned off. Here, the ON frame period is the frame period during which pixel data is written to the pixels, causing the pixels to turn on, while the OFF (Black) frame period is the frame period during which black grayscale data is written to the pixels, causing the pixels to turn off. When the normal mode is switched to the ultra-low grayscale mode, the first frame period of the ultra-low grayscale mode may be controlled as the OFF (Black) frame period, and the second frame period of the ultra-low grayscale mode may be controlled as the ON frame period. To sufficiently secure a time for which the gamma reference voltage is changed and to prevent change in luminance of the pixels from being visible, the gamma reference voltage is changed in the OFF frame period.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure may be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure. The scope of protection of the present disclosure should be construed based on the following claims, and all technical features within the scope of equivalents thereof should be construed as being included within the scope of the present disclosure.

What is claimed is:

1. A pixel control method, comprising:
setting a maximum grayscale value of one-frame data in an input image as a maximum input grayscale;
matching the maximum input grayscale with a maximum output grayscale and matching input grayscales equal to or smaller than the maximum input grayscale with grayscales equal to or smaller than the maximum output grayscale; and
selecting duty data controlling a lighting period of pixels according to the maximum input grayscale,
wherein the maximum input grayscale varies depending on a maximum grayscale value of the input image,
the maximum output grayscale is a grayscale value determined according to a number of bits of pixel data, and
the lighting period of the pixels indicated by the duty data varies depending on the maximum input grayscale.

2. The pixel control method according to claim 1, wherein the duty data includes duty ratio information of a light emission signal that changes in a form of any one of linear, nonlinear, and stepwise depending on the maximum input grayscale, and
the light emission signal is applied to pixels to which the pixel data is written.

3. The pixel control method according to claim 1, wherein a light emission time of the pixels is decreased when a duty ratio of the duty data is decreased.

4. The pixel control method according to claim 1, further comprising:
determining whether the maximum input grayscale belongs to an ultra-low grayscale range relatively lower in a low grayscale range;
controlling the pixels in a normal mode when the maximum input grayscale belongs to a grayscale range outside the ultra-low grayscale range and controlling a frame rate to a reference frequency in the normal mode; and
controlling the pixels in an ultra-low grayscale mode when the maximum input grayscale belongs to the ultra-low grayscale range, increasing the frame rate to a frequency higher than the reference frequency in the ultra-low grayscale mode, and increasing a data voltage that is output from a data driver.

5. The pixel control method according to claim 4, further comprising:
increasing a gamma reference voltage that is supplied to the data driver, in the ultra-low grayscale mode.

6. The pixel control method according to claim 5, further comprising:
adding an off-frame period during which black grayscale data set regardless of the pixel data of the input image is written to the pixels, in the ultra-low grayscale mode.

7. The pixel control method according to claim 6, further comprising:
changing the gamma reference voltage in the off-frame period.

8. A display device, comprising:
at least one display panel in which data lines, gate lines, and pixels are provided;
a data driver configured to convert pixel data into a data voltage and supply the data voltage to the data lines;
a gate driver configured to supply gate signals to the gate lines; and
a timing controller configured to transmit the pixel data to the data driver and control the data driver and the gate driver,
wherein the timing controller includes:
a maximum grayscale detector configured to set a maximum grayscale value of one-frame data of an input image as a maximum input grayscale;
a pixel data converter configured to match the maximum input grayscale with a maximum output grayscale and match input grayscales equal to or smaller than the maximum input grayscale with grayscales equal to or smaller than the maximum output grayscale; and
a duty calculator configured to select duty data of a light emission signal controlling a lighting period of the pixels according to the maximum input grayscale, and
wherein the maximum input grayscale varies depending on a maximum grayscale value of the input image,
the maximum output grayscale is a grayscale value determined according to a number of bits of pixel data,
the lighting period of the pixels indicated by the duty data varies depending on the maximum input grayscale, and
the gate signals include the light emission signal.

9. The display device according to claim 8, wherein each of the pixels includes at least a red subpixel, a green subpixel, and a blue subpixel, and
wherein each of the red subpixel, the green subpixel, and the blue subpixel includes:
a driving transistor and a light-emitting element connected in series between a pixel driving voltage and a pixel ground voltage; and
a switch transistor that is connected between the driving transistor and the pixel ground voltage or between the driving transistor and the light-emitting element, and is turned on in response to a gate-on voltage of the light emission signal.

10. The display device according to claim 8, wherein the gate driver includes:
a first light emission (EM) driver configured to receive a first start pulse and a first clock as input and supply a first light emission signal to pixels provided in a first display area of the display panel;
a second EM driver configured to receive a second start pulse and a second clock as input and supply a second light emission signal to pixels provided in a second display area of the display panel; and
a third EM driver configured to receive a third start pulse and a third clock as input and supply a third light emission signal to pixels provided in a third display area of the display panel.

11. The display device according to claim 10, wherein the timing controller is configured to:
select a maximum grayscale value among grayscale values of pixel data to be written to the pixels in the first display area of the display panel as a first maximum input grayscale and output first duty data selected according to the first maximum input grayscale;
select a maximum grayscale value among grayscale values of pixel data to be written to the pixels in the second display area of the display panel as a second maximum input grayscale and output second duty data selected according to the second maximum input grayscale; and
select a maximum grayscale value among grayscale values of pixel data to be written to the pixels in the third display area of the display panel as a third maximum input grayscale and output third duty data selected according to the third maximum input grayscale,
wherein the first duty data includes duty ratio information of the first start pulse and the first clock,
the second duty data includes duty ratio information of the second start pulse and the second clock, and
the third duty data includes duty ratio information of the third start pulse and the third clock, and
wherein a duty ratio of the first light emission signal changes in proportion to duty ratios of the first start pulse and the first clock,
a duty ratio of the second light emission signal changes in proportion to duty ratios of the second start pulse and the second clock, and
a duty ratio of the third light emission signal changes in proportion to duty ratios of the third start pulse and the third clock.

12. The display device according to claim 10, wherein the first EM driver is provided in the first display area,
the second EM driver is provided in the second display area, and
the third EM driver is provided in the third display area.

13. The display device according to claim 8, wherein the at least one display panel includes:
a first display panel in which a first gate driver is provided in a display area; and
a second display panel in which a second gate driver is provided in a display area, and
wherein the first gate driver includes a first EM driver configured to receive a first start pulse and a first clock as input and supply a first light emission signal to pixels provided in the display area of the first display panel, and
the second gate driver includes a second EM driver configured to receive a second start pulse and a second clock as input and supply a second light emission signal to pixels provided in the display area of the second display panel.

14. The display device according to claim 13, wherein the timing controller is configured to:
select a maximum grayscale value among grayscale values of pixel data to be written to the pixels in the first display panel as a first maximum input grayscale and output first duty data selected according to the first maximum input grayscale; and
select a maximum grayscale value among grayscale values of pixel data to be written to the pixels in the second display panel as a second maximum input grayscale and output second duty data selected according to the second maximum input grayscale,
wherein the first duty data includes duty ratio information of the first start pulse and the first clock, and
the second duty data includes duty ratio information of the second start pulse and the second clock, and
wherein a duty ratio of the first light emission signal changes in proportion to duty ratios of the first start pulse and the first clock, and
a duty ratio of the second light emission signal changes in proportion to duty ratios of the second start pulse and the second clock.

15. The display device according to claim 8, wherein the timing controller is configured to:
determine whether the maximum input grayscale belongs to an ultra-low grayscale range relatively lower in a low grayscale range;
control the pixels in a normal mode when the maximum input grayscale belongs to a grayscale range outside the ultra-low grayscale range and control a frame rate to a reference frequency in the normal mode; and
control the pixels in an ultra-low grayscale mode when the maximum input grayscale belongs to the ultra-low grayscale range, increase the frame rate to a frequency higher than the reference frequency in the ultra-low grayscale mode, and increase a data voltage that is output from the data driver.

16. The display device according to claim 15, further comprising:
a gamma reference voltage supplier configured to supply a gamma reference voltage to the data driver,
wherein the timing controller is configured to increase the gamma reference voltage that is output from the gamma reference voltage supplier, in the ultra-low grayscale mode.

17. The display device according to claim 16, wherein the timing controller adds an off-frame period during which black grayscale data set regardless of pixel data in the input image is written to pixels.

18. The display device according to claim 17, wherein the gamma reference voltage is changed in the off-frame period.
